(19) United States
(12) Patent Application Publication
(10) Pub. No.: US 2026/0066520 A1
(43) Pub. Date: Mar. 5, 2026

(54) ANTENNA MOUNTING AND ROTATIONAL POSITIONING APPARATUS AND METHOD

(71) Applicant: Dimitris KOLOKOTRONIS, Athens (GR)

(72) Inventor: Dimitris KOLOKOTRONIS, Athens (GR)

(21) Appl. No.: 18/995,802

(22) PCT Filed: Jul. 17, 2023
(86) PCT No.: PCT/EP2023/069796

§ 371 Date: Jan. 16, 2025

(30) Foreign Application Priority Data
Jul. 18, 2022 (GB) 2210520.9

(51) Int. Cl. H01Q 1/12; H01Q 1/46; H01Q 3/06

(52) U.S. Cl. CPC H01Q 1/1264; H01Q 3/06; H01Q 1/46

(57) ABSTRACT

An antenna steering and locking unit has an antenna mounting housing (616), a shaft (700) rotatable relative to the antenna mounting housing, a first one of the shaft and the antenna mounting housing being mountable to an antenna mounting structure, a second of the shaft and the housing being attached to an antenna and a locking mechanism (608) disposed within the antenna mounting housing. The locking mechanism may be e.g. a clutch or a rotary indexer. The shaft may support an antenna via clamps.

The present application is concerned with an apparatus and method for accurately and repeatably rotatably positioning an antenna. More specifically, the present invention is concerned with an apparatus and method for accurate and repeatable azimuth steering and locking.

Antenna structures are used by wireless telecommunications networks and service providers to mount antenna systems at a desired height from the ground for uninterrupted transmission and reception of radio signals between the antenna and a device operated by a user or system. Such devices are typically mobile devices such as cellular phones or other connected devices.

A typical telecommunications antenna is of a directional radiation pattern, comprising an elongate, planar metal reflector and a series of dipoles (array) positioned in a line along the surface of the reflector. Such antennas can be 2 metres in height or more. Usually, a cover is used to cover the dipoles in order to environmentally protect them. The cover is configured to be as transparent to electromagnetic radiation as possible in the frequency range they intend to operate in order not to affect the transmitted signal radio propagation characteristics. Cover materials having a substantial plastics material component such as GRP or ASA are commonly used.

As modern wireless telecommunication networks are deploying broadband technologies for higher data rates (e.g. 4G/5G) the positioning of such antennas in an absolute, global sense is increasingly important. This is particularly true since broadband technologies are interference limited technologies. This means that higher the signal to interference ratio (C/I), the lower are the maximum data rates that can be achieved. The finite transmitted power from an antenna needs to be accurately directed to the planned target area in order to keep the signal to interference ratio under control. Accurate positioning of antennas reduces unwanted interference between adjacent sectors while directing the maximum signal power where is needed thus achieving minimum signal to interference ratio both inside and outside the target sector.

Capacity oriented network architectures should deploy antennas that can be dynamically adjustable such that their radiation pattern can redirect the finite frequency resources from one area to another. More advanced antennas are remotely adjustable via electrical motors (or other means) such that their azimuth and tilt angles can be adjusted in order to provide the best possible coverage. For example if a large number of users are in a certain area then a group of antennas can be realigned such that their respective coverage offers the required capacity for that area. As such, it is very important that the absolute direction of the antenna is known, so that its position can be accurately adjusted.

Desired antenna position is usually determined through a radio planning process, carried out by the network operator. This process provides details of the desired global position of the antenna, as well as specific values of heading, tilt and roll.

To achieve high network performance, provide high quality radio link transmissions and reception and ensure high spectrum efficiency, directional antennas must be aligned with minimum inaccuracy (less than ±1°) in the degrees of freedom (heading, tilt and roll). Accurate alignment of directional antennas is of paramount importance in a competitive wireless communication industry, as even small errors in azimuth and tilt alignment (more than ±5° for azimuth and more than ±1° for tilt) can seriously degrade radio network quality.

U.S. Pat. No. 9,437,918 discloses an antenna mounting bracket with adjustable azimuth settings. The bracket allows remote adjustment. The bracket comprises a drive motor that can rotate the antenna about the azimuth steering axis, and a separate, automated locking pin and plate arrangement to lock the antenna in one of a plurality of predetermined angular positions. In order to move the antenna from a first position to a second position, the locking pin is disengaged, the drive motor engaged to rotate the antenna to the second position and the locking pin re-engaged.

US2016/0211576 discloses an assembly for a mobile communications antenna system, the assembly having an azimuth steering arrangement.

US2018/0013200 discloses a steering and tilt bracket for an antenna in which a drive motor is used to steer the antenna.

WO2013171291 discloses an apparatus and method for accurate and precise positioning of cellular antennas. In this application, a global positioning apparatus is used to determine a datum. Local position transducers are used to measure the position of the antennas relative to the datum. In this way, the absolute, global position of the antennas (e.g. in the azimuth steering plane) are known.

This system typically uses a steering mechanism (for example a rotational joint, which may be driven by a motor) and a locking mechanism (for example a pin/plate type arrangement) to lock the antenna into one of a plurality of predetermined angular positions relative to the datum.

Due to the modern networks'dynamic nature, repeatable antenna azimuth and tilt re-adjustment during the lifecycle of a base station site (for one or more antenna systems) is required; therefore, the antenna brackets, the antennas or the antenna structure itself should be capable of facilitating such needs. Antenna azimuth and tilt readjustment has to be performed with the same high degree of accuracy as the original installation.

Antenna azimuth and tilt re-adjustment should ideally take place without the need to climb on the tower top and manually adjust the antenna position. Manual reposition involves high operational expenditure (OPEX) due to climbing, as well as health and safety risks for antenna technicians, riggers and climbers. It is also desirable to reduce human exposure to the strong electromagnetic fields proximate the antennas. At present, most network operators inhibit antenna operation during the time that such works are performed on the antenna system, thus preventing coverage from the selected antenna and/or base station. This is also undesirable.

A further problem with directing antennas in the desired direction, in particular by remote actuation, is “play”, or free movement, in the actuation system. The use of electric motors and gear trains results in some inevitable backlash which can cause the antenna to move in use. In particular worm gears (which offer an advantage in gearing) have typically high backlash.

A problem with existing antenna installations is the fact that they are generally exposed to the external environment, i.e., repeated cyclical wind loading on the antenna. The repeated buffeting of the antenna over time may cause wear in the antenna mounting components, in particular if a remotely driven antenna is provided. Therefore the life cycle of these components is limited. One solution is to cover the entire assembly with a radome, however this restricts the space available requiring any adjustment mechanism to be integrated with the antenna itself.

A problem with high-aspect ratio or “tall” directional antennas is that they typically comprise two spaced-apart mounting points. If steering and locking is required, then the installer either needs to position a single steering and locking mechanism on one mounting point with the other being “free” to rotate, or provide steering and locking mechanisms on both mounting points. The former solution may invite torsion across the height of the antenna under loading (which is problematic), buy the latter solution requires synchronisation between the steering mechanisms and/or alignment of the locking mechanisms, which is technically difficult over a period of many steering and locking cycles.

Further, providing two automated steering and locking mechanisms involves the provision of four actuators (two steering motors, two locking actuators) which adds weight and expense.

It is an aim of the present invention to overcome, or at least mitigate the problems with the prior art.

According to a first aspect of the present invention there is provided an antenna steering and locking unit comprising:
an antenna mounting housing;
a shaft rotatable relative to the antenna mounting housing;
a first one of the shaft and the antenna mounting housing being mountable to an antenna mounting structure, a second of the shaft and the housing being attached to an antenna; and,
a locking mechanism disposed within the antenna mounting housing, the locking mechanism comprising a first clutch plate connected to the shaft, and a second clutch plate connected to the housing, the locking mechanism being actuable by relative axial movement of the clutch plates between:
a first, unlocked, condition in which the shaft can rotate relative to the antenna mounting housing; and,
a second, locked, condition in which the shaft is fixed relative to the antenna mounting housing.

Preferably each of the first and second clutch plates comprising a plurality of spaced apart teeth, and in the locked condition the teeth of the respective formations are engaged.

Preferably the first formation and the second formation comprise teeth extending in opposed and facing axial directions.

Preferably the respective teeth of the first formation and the second formation define an annular path around an axis of rotation of the shaft.

Preferably the locking mechanism is a dog clutch.

Preferably the first formation and the second formation comprise teeth extending in opposed and facing radial directions.

Preferably the respective teeth of the first formation and the second formation define a circular path around an axis of rotation of the shaft to form a respective first and second gear formation.

Preferably a recessed portion is provided adjacent the second gear formation, and wherein the second gear formation and the recessed portion are offset along the articulation axis such that movement of the first gear formation in an axial direction moves the locking mechanism between the first and second conditions.

Preferably the housing has a cylindrical inner surface, and wherein the teeth of the second formation are defined on the circular inner surface.

Preferably one of the first formation and the second formation is axially moveable via a cam.

Preferably the cam is defined on a rotatable annular surface, and in which the one of the first formation and the second formation is connected to a cam follower.

Preferably the rotatable annular surface is defined on a collar, the collar being driven by an actuator.

Preferably the cam follower is a follower shaft passing through the shaft normal thereto.

Preferably the antenna is connected to the shaft directly.

Preferably the antenna is connected to the shaft via an intermediate mounting member.

Preferably the intermediate mounting member comprises a hollow prismatic member.

Preferably the intermediate mounting member comprises a cylindrical pipe member.

Preferably the antenna is attached to the cylindrical pipe member with a clamp.

According to a second aspect of the invention there is provided an antenna steering and locking unit comprising:
an antenna mounting housing;
a shaft rotatable relative to the antenna mounting housing;
a first one of the shaft and the antenna mounting housing being mountable to an antenna mounting structure, a second of the shaft and the antenna mounting housing being attached to an antenna; and,
a rotary indexer mounted to the antenna mounting housing, the rotary indexer having a rotary input, and an intermittent output alternating between:
a first, unlocked, condition in which the shaft rotates relative to the antenna mounting housing; and,
a second, locked, condition in which the shaft is fixed to the antenna mounting housing.

Preferably the rotary indexer comprises a drive phase and a dwell phase, wherein the dwell phase represents the locked condition, and the dive phase represents the unlocked condition.

Preferably the rotary indexer comprises a Geneva wheel mechanism.

Preferably the Geneva wheel mechanism comprises a Geneva wheel having an external formation.

Preferably the intermittent output drives a pinion gear which in turn drives a partial or complete ring gear connected to the shaft.

Preferably the antenna is connected to the shaft directly.

Preferably the antenna is connected to the shaft via an intermediate mounting member.

Preferably the intermediate mounting member comprises a hollow prismatic member.

Preferably the intermediate mounting member comprises a cylindrical pipe member.

Preferably the antenna is attached to the cylindrical pipe member with a clamp.

According to a third aspect of the invention there is provided an antenna mounting apparatus comprising:
a locking unit;
at least one hollow cylindrical section connected to the locking unit;
wherein the locking unit is configured to selectively allow and inhibit rotation of the hollow cylindrical section about a steering axis;
an antenna;
a first clamp and a second clamp, each clamp attached to the antenna in spaced apart positions, and each clamp clamping the at least one hollow cylindrical section.

Preferably the locking unit comprises a friction clamp.

Preferably the locking unit comprises a locking pin engageable with any of a plurality of receiving formations in a locking plate.

Preferably the locking unit is a first steering and locking unit, the first steering and locking unit having a bearing supporting rotation of the hollow cylindrical section.

Preferably the first steering and locking unit has an actuator for rotating the hollow cylindrical section

Preferably the apparatus comprises:
a second steering and locking unit;
the first and second steering and locking units connected to a hollow cylindrical section at spaced apart positions.

Preferably the first clamp and the second clamp each clamp the hollow cylindrical section at spaced apart positions between the steering and locking units.

Preferably the first and/or second steering and locking units comprise a rotary output shaft, each respective rotary output shaft connected to a respective open end of a common hollow cylindrical section.

Preferably each respective rotary output shaft extends within the respective open end of the common hollow cylindrical section.

Preferably spokes extend from each rotary output shaft to engage the common hollow cylindrical section.

Preferably the first and second steering and locking units are actuated between a locked and an unlocked condition by axial motion, which axial motion is transmitted between the first and second steering and locking mechanisms via the hollow cylindrical section.

Preferably the apparatus comprises:
a second steering and locking unit;
the first and second steering and locking units connected to respective distinct hollow cylindrical sections;
wherein the first clamp and the second clamp each clamp a respective hollow cylindrical section.

According to a fourth aspect of the invention there is provided an antenna mounting apparatus comprising:
a master locking and steering unit for mounting the antenna to a fixed structure, the master locking and steering unit provided at a first position on the antenna;
a slave locking and steering unit for mounting the antenna to the fixed structure, the slave locking and steering unit provided at a second position on the antenna, spaced apart from the first;
wherein:
the slave locking and steering unit has a locked condition and an unlocked condition, and movement from the locked condition to the unlocked condition is provided by a motion input; and,
the master locking and steering unit has a locked condition and an unlocked condition, and movement between the locked condition and unlocked is coupled to the motion input to the slave locking and steering unit.

The present invention therefore provides a system whereby the antenna is locked at two positions (for example at each end). This avoids torsion loading on the antenna and does away with complex electronic systems having motors/locking systems at both ends. The slave unit merely needs a mechanical input.

Preferably the master locking and steering unit is active, and wherein the slave locking and steering unit is passive. By “active” we mean that the master unit is powered and by “passive” we mean that the slave unit is unpowered.

Preferably the motion input is a motion along an azimuth steering axis of the antenna.

Preferably the motion input is a motion of the antenna.

Preferably the master locking and steering unit comprises a lifting mechanism to move the antenna parallel to the azimuth steering axis.

Preferably the lifting mechanism comprises a rotational input.

Preferably the lifting mechanism comprises a cam and follower, the cam driven by the rotation input to drive the follower parallel to the azimuth steering axis.

Preferably at least one of the master locking and steering unit and slave locking and steering unit comprises:
a housing;
a first locking formation connected to an output shaft;
a second locking formation connected to the housing;
wherein:
in the locked condition the first locking formation and the second locking formations are engaged; and,
in the unlocked condition the first locking formation and the second locking formation are disengaged to allow rotation of the output shaft.

Preferably the master locking and steering unit has an articulation axis for steering the antenna, and at least one of the first and second locking formations are moved in a direction parallel to the articulation axis to move between the locked and unlocked conditions.

Preferably the locking formations are formed from radially extending teeth.

Preferably:
one of the first and second locking formations comprises a first gear formation having teeth;
the other of the first and second locking formations comprises:
   a second gear formation corresponding to the first gear formation; and,
   a recessed portion adjacent the second gear formation;
   wherein the second gear formation and the recessed portion are offset along the articulation axis.

Preferably the locking formations are formed from axially extending teeth.

Preferably the first and second locking formations are part of a dog clutch.

Preferably the master locking and steering unit comprises a rotary indexer.

Preferably the rotary indexer comprises a drive phase and a dwell phase, wherein the dwell phase represents the locked condition, and the dive phase represents the unlocked condition.

Preferably the motion input is provided by a lifting cam coupled to an input to the rotary indexer, and a steering input is provided by the output from the rotary indexer during the drive phase.

Preferably the antenna mounting apparatus comprises a plurality of slave locking and steering units, each moved between the locked an unlocked condition by the motion input of the master locking and steering unit.

Preferably the master and slave locking and steering units are each provided with a mast clamp, the mast clamp configured to clamp a structural mast section and comprising means for attachment of the respective steering and locking mechanism.

Preferably the master locking and steering apparatus is driven by an electric motor.

The master locking and steering apparatus and the slave locking and steering apparatus define a common azimuth steering axis.

Most directional antenna arrays are elongate, and preferably the antenna has a length (i.e., a longest dimension) parallel to the azimuth steering axis.

According to the invention there is provided a method of positioning a directional antenna comprising the steps of:
providing an antenna mounting apparatus according to the first aspect;
attaching the master locking and steering unit to a fixed structure;
attaching the slave locking and steering unit to the fixed structure;
using the antenna mounting apparatus to rotate the directional antenna relative to the fixed structure.

Preferably the method comprises the steps of:
providing a global position sensing apparatus;
determining a global position and/or orientation of a part of the fixed structure using the global position sensing apparatus;
removing the global position sensing apparatus from the fixed structure;
using the antenna mounting apparatus to rotate the directional antenna relative to the part of the fixed structure.

Preferably the method comprises the steps of:
providing:
   a rotary actuator configured to drive the input shaft; and,
   a controller configured to deliver a drive input to the rotary actuator to rotate the second portion;
using the controller to position the antenna according to global position and/or orientation requirements using the global position and/or orientation of the part of the fixed structure.

An example antenna mounting apparatus according to the present invention will now be described with reference to the accompanying drawings in which:

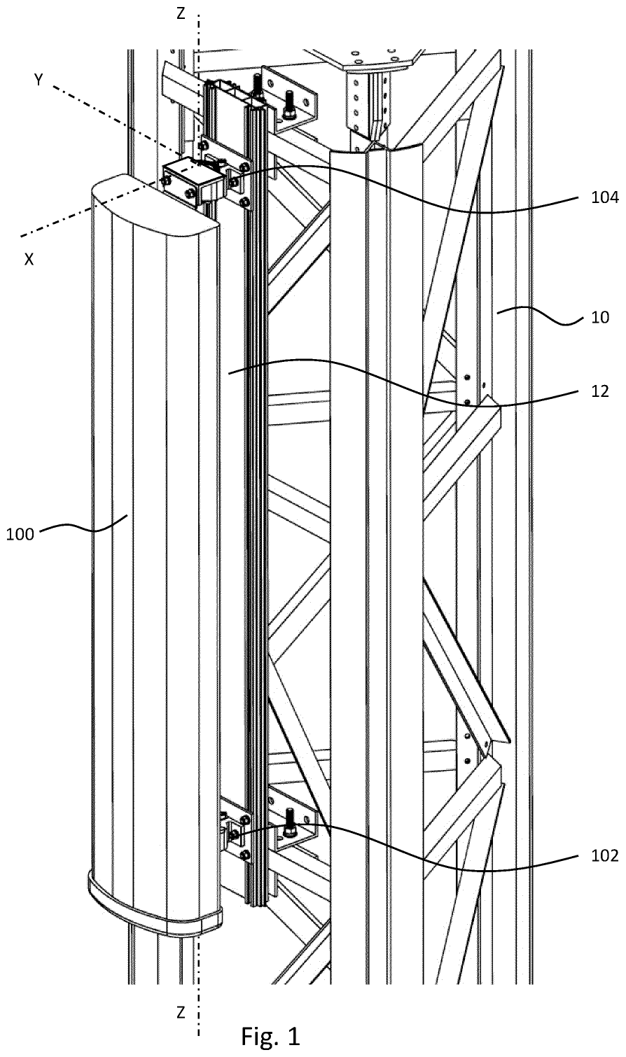

FIG. 1 is a perspective view of an antenna mounted to an antenna mast;

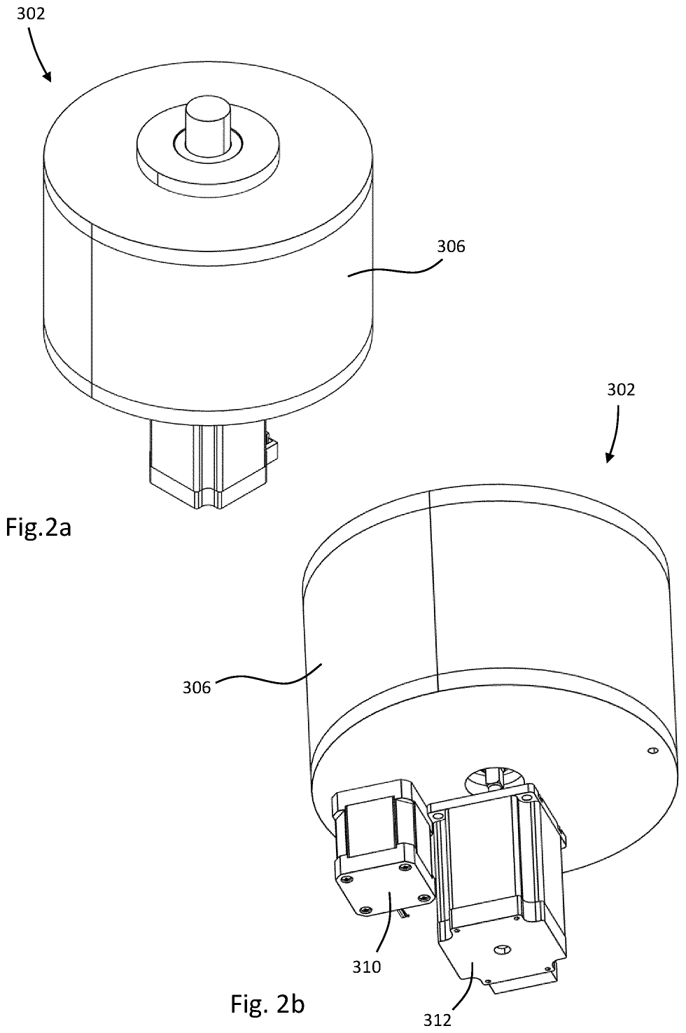

FIGS. 2a and 2b are perspective views of a first drive mounting unit of a first embodiment of the present invention;

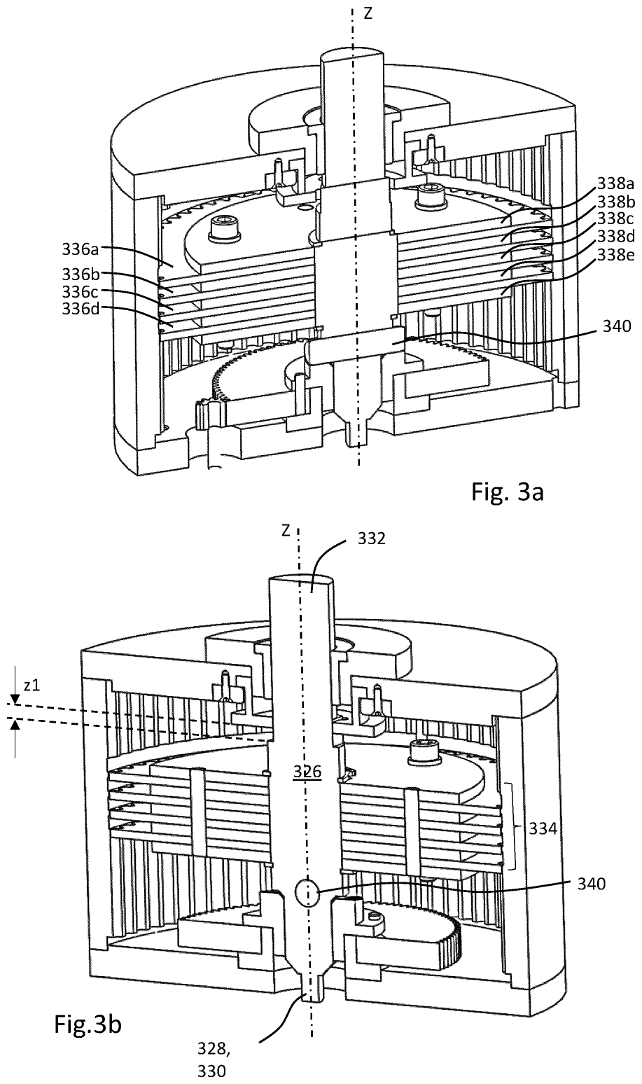

FIGS. 3a and 3b are section views through the major axis of the unit of FIGS. 2a and 2b;

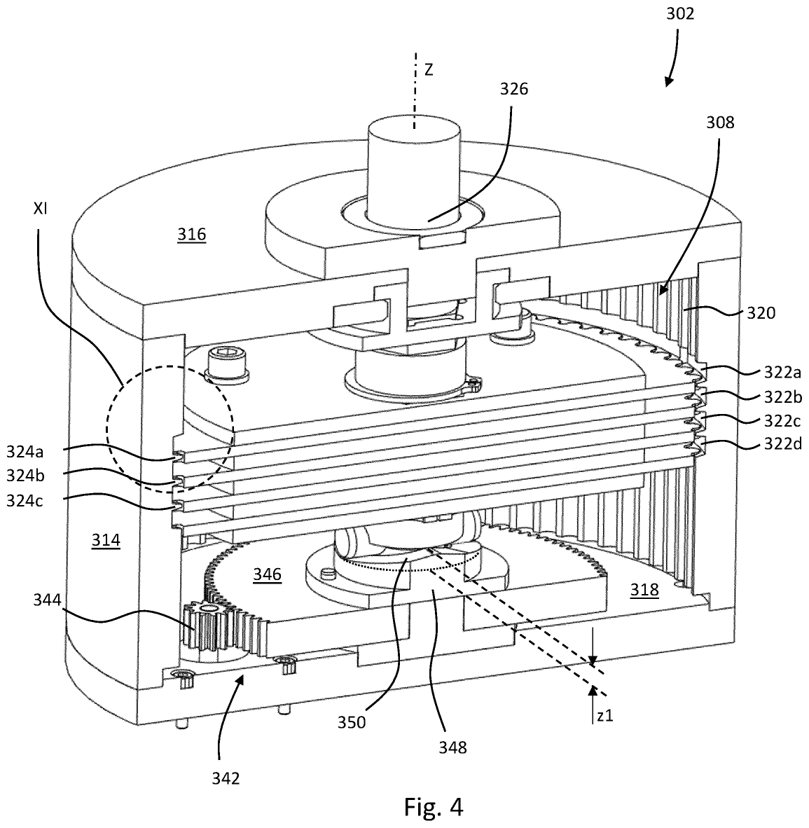

FIG. 4 is a perspective section view of the unit of FIGS. 2a and 2b;

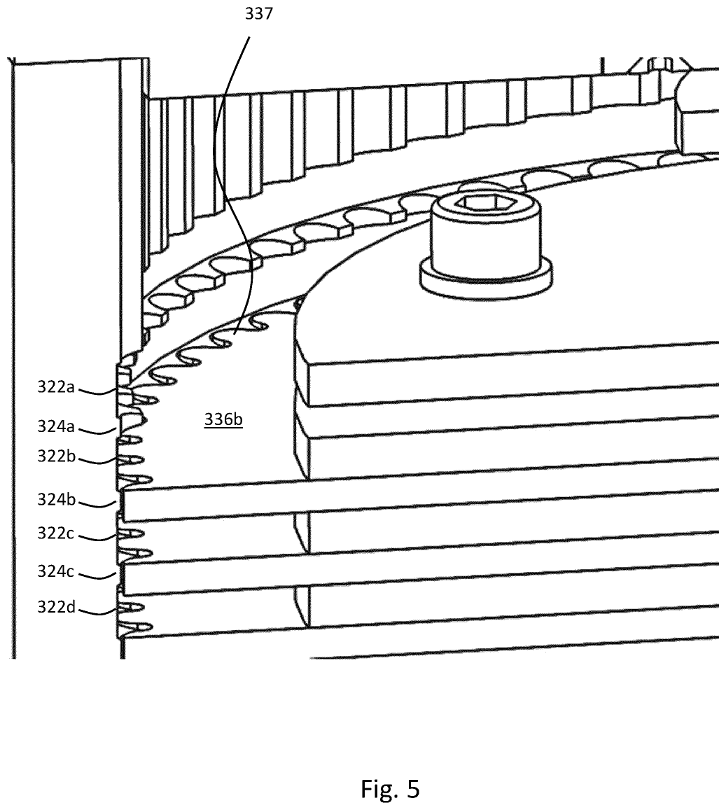

FIG. 5 is a detail section view of a part of the unit of FIGS. 2a and 2b;

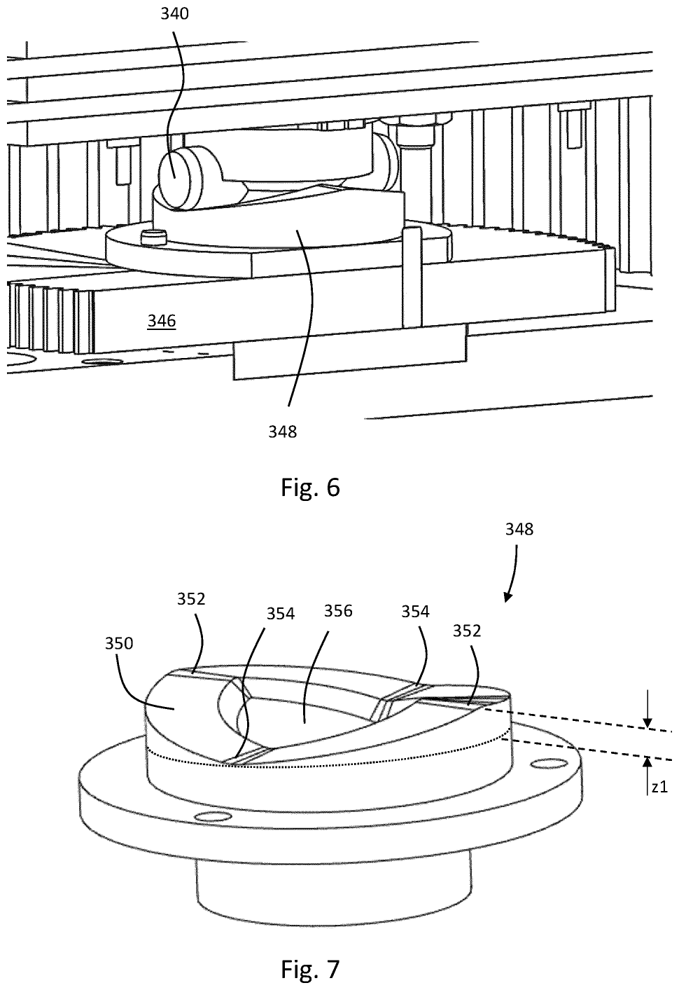

FIG. 6 is a detail section view of a part of the unit of FIGS. 2a and 2b;

FIG. 7 is a perspective view of a part of the unit of FIGS. 2a and 2b;

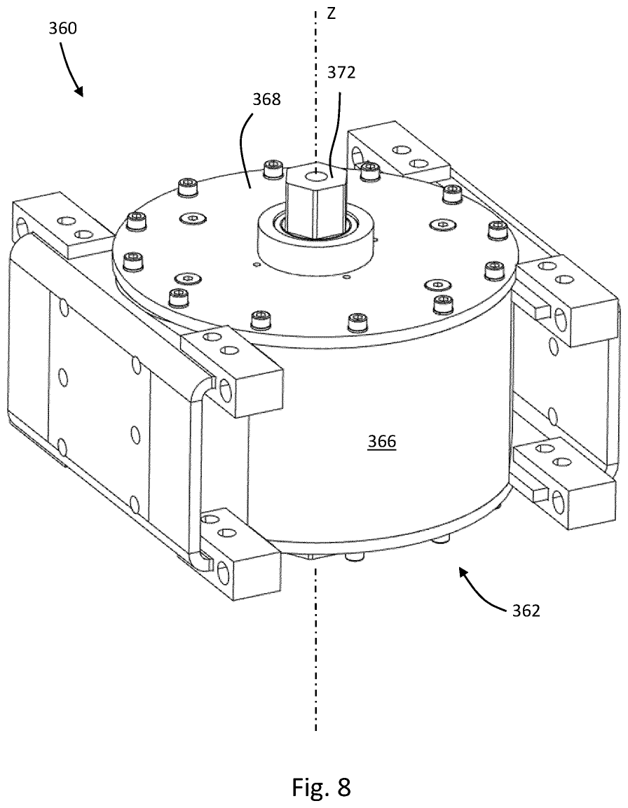

FIG. 8 is a perspective view of a second drive mounting unit of the first embodiment of the present invention;

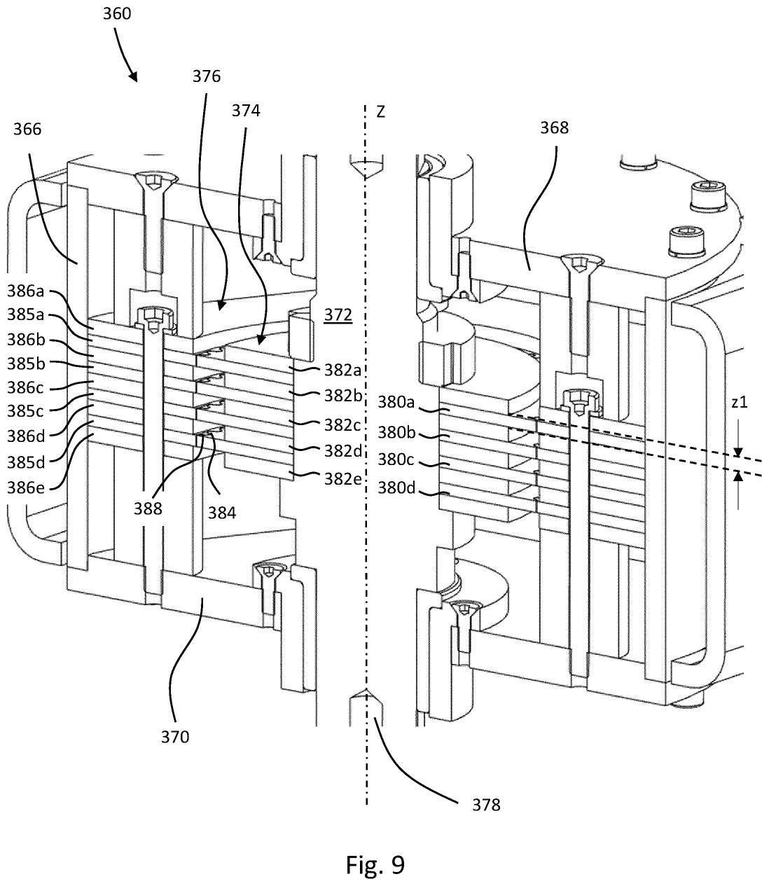

FIG. 9 is a perspective section view of the second drive mounting unit of FIG. 8;

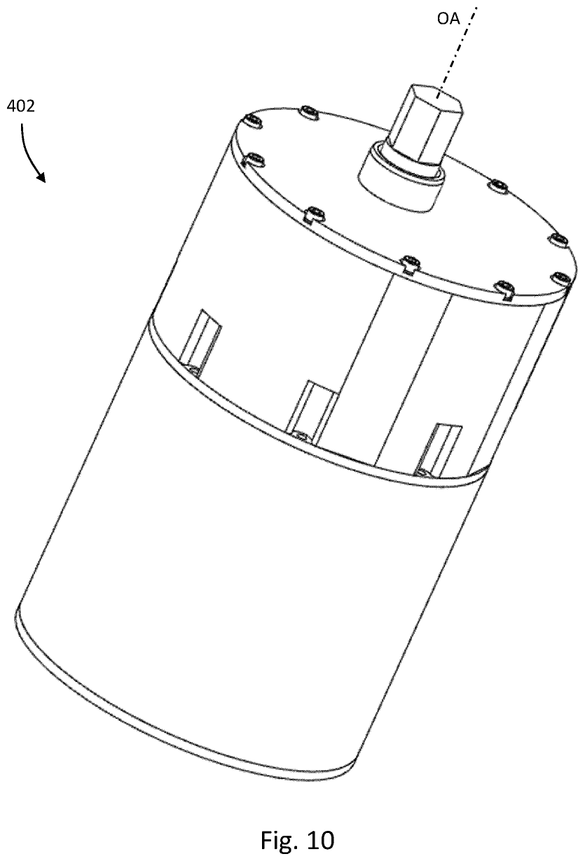

FIG. 10 a perspective view of a first drive mounting unit according to a second embodiment of the present invention;

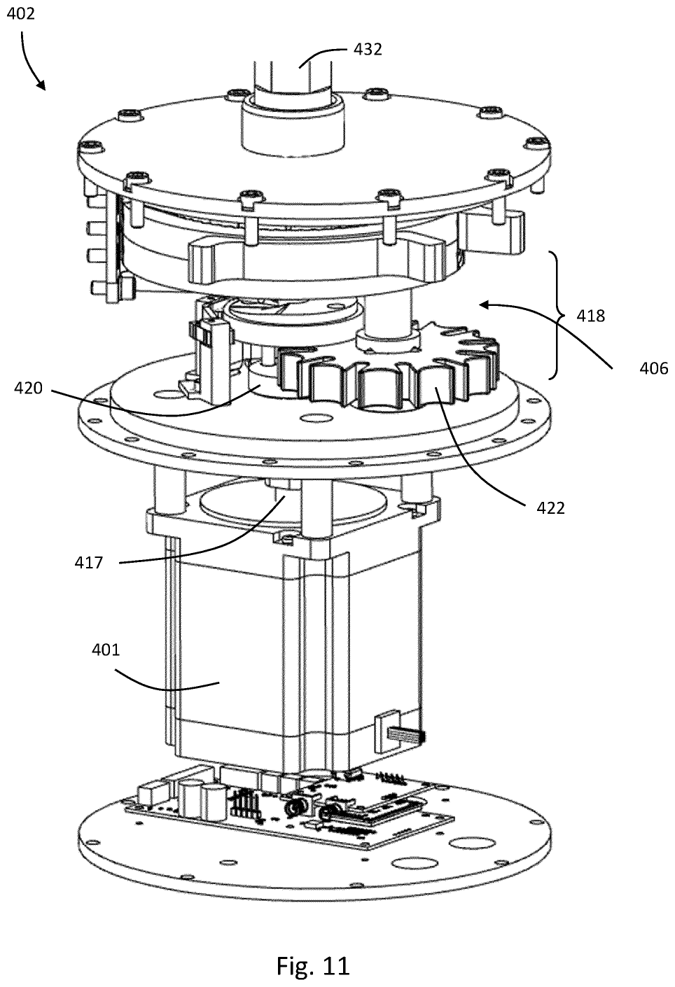

FIG. 11 is a perspective the drive mounting unit of FIG. 10 with some parts omitted;

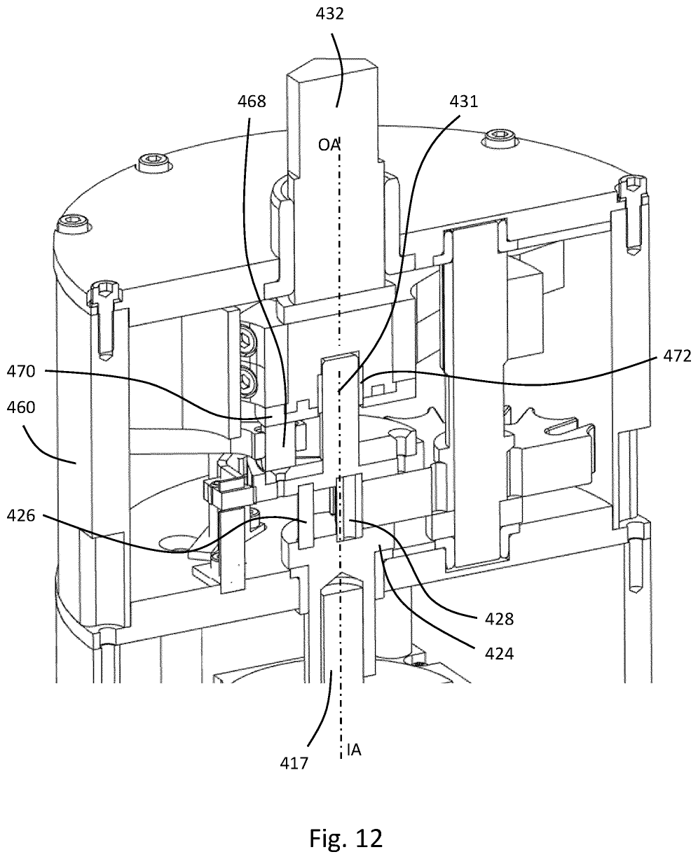

FIG. 12 is a perspective section view of a part of the unit of FIG. 10;

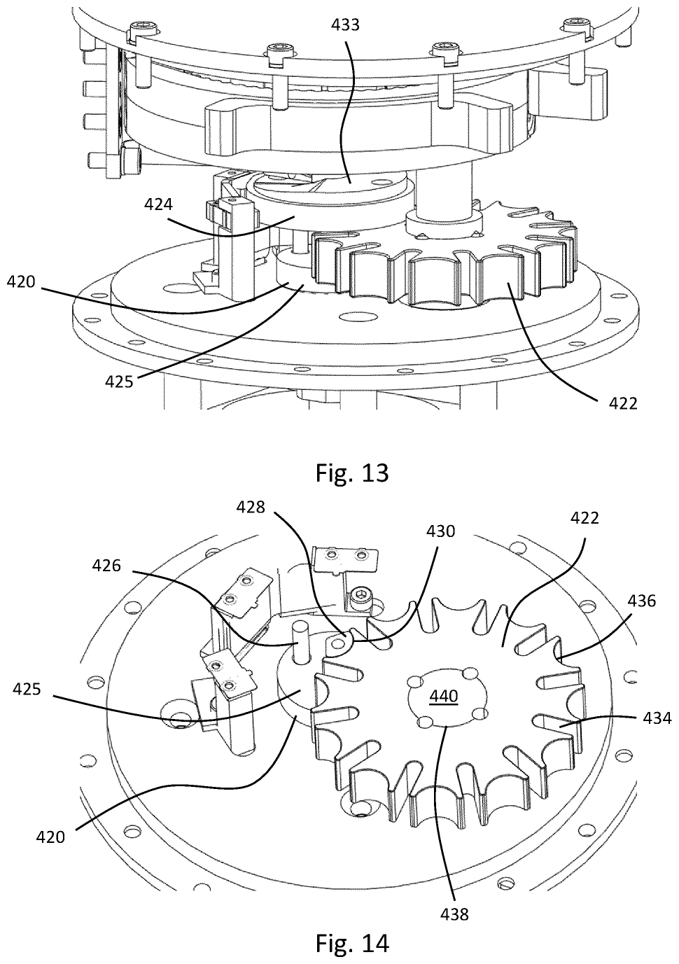

FIGS. 13 and 14 are detail perspective views of the unit of FIG. 10;

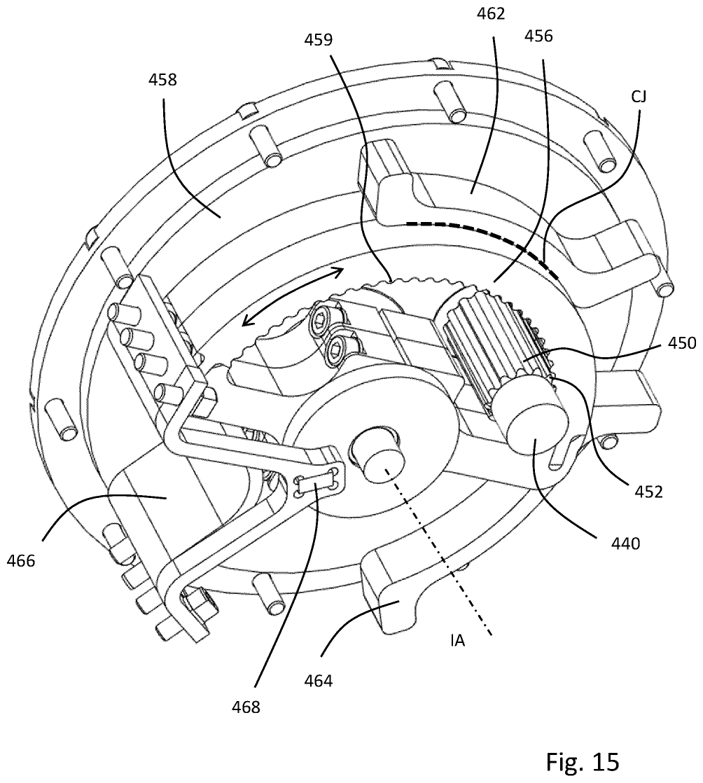

FIG. 15 is a perspective section detail view of a part of the unit of FIG. 10;

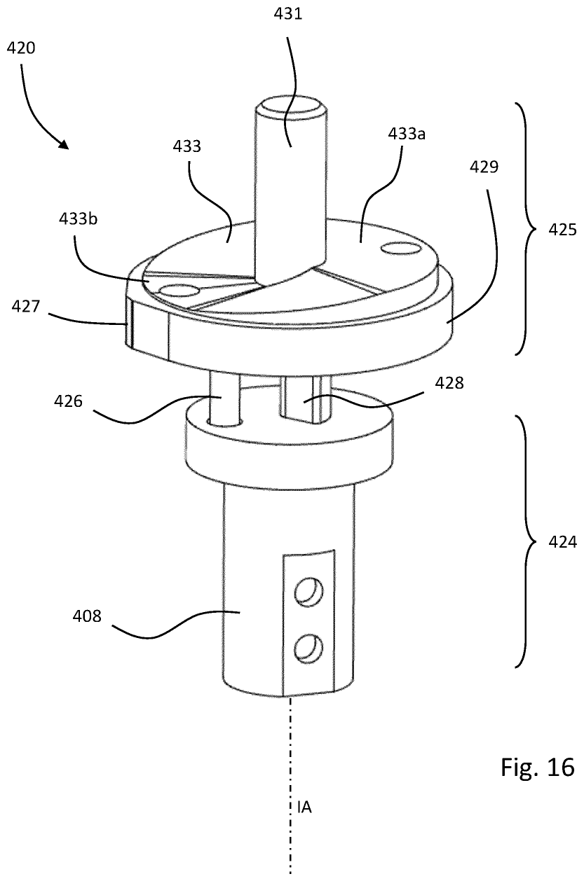

FIG. 16 is a detailed view of a component of the unit of FIG. 10;

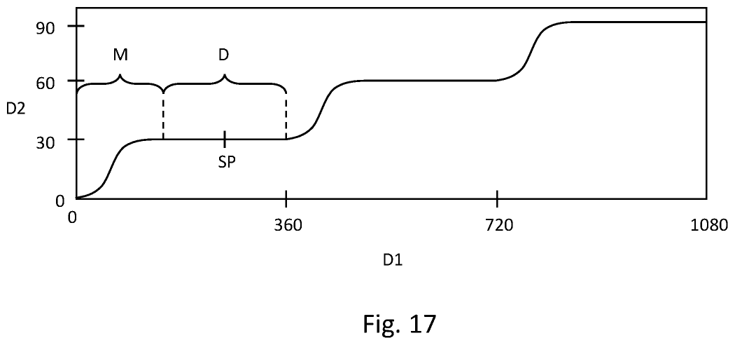

FIG. 17 is a motion graph of a part of the mechanism of FIG. 10;

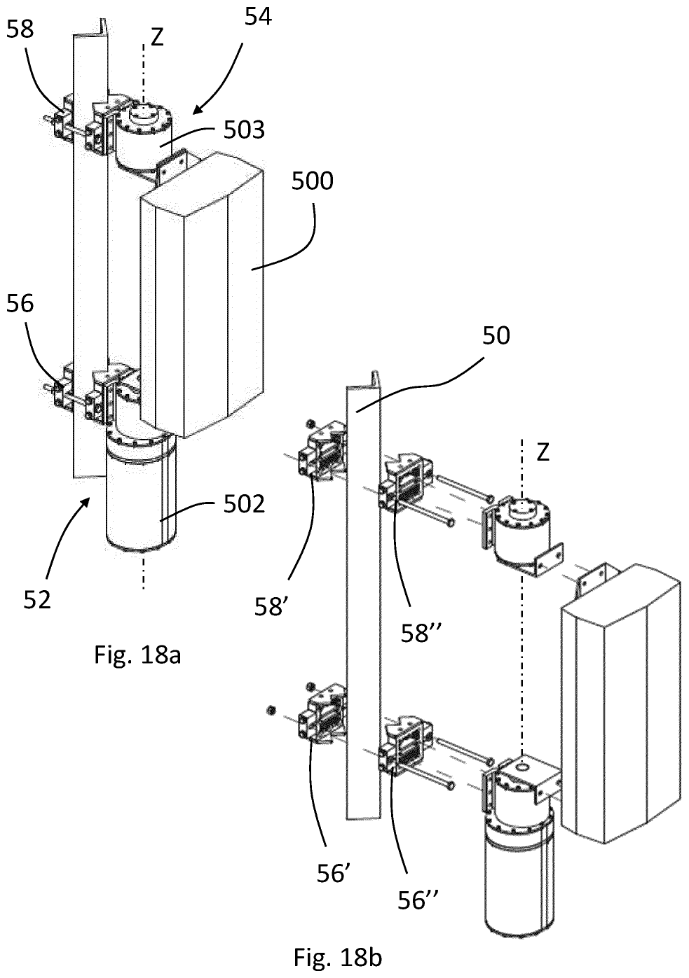

FIGS. 18a and 18b are perspective views of two antennas mounted to an antenna mast;

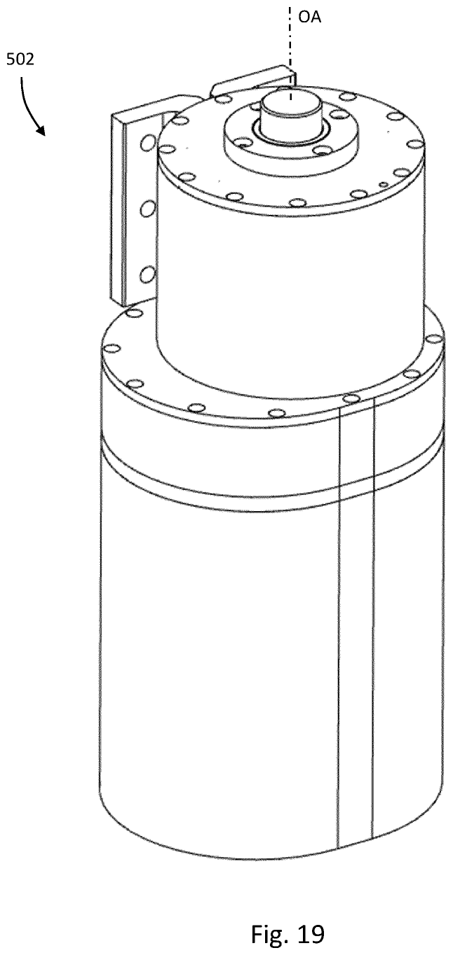

FIG. 19 is a perspective view of a first drive mounting unit of a third embodiment of the present invention;

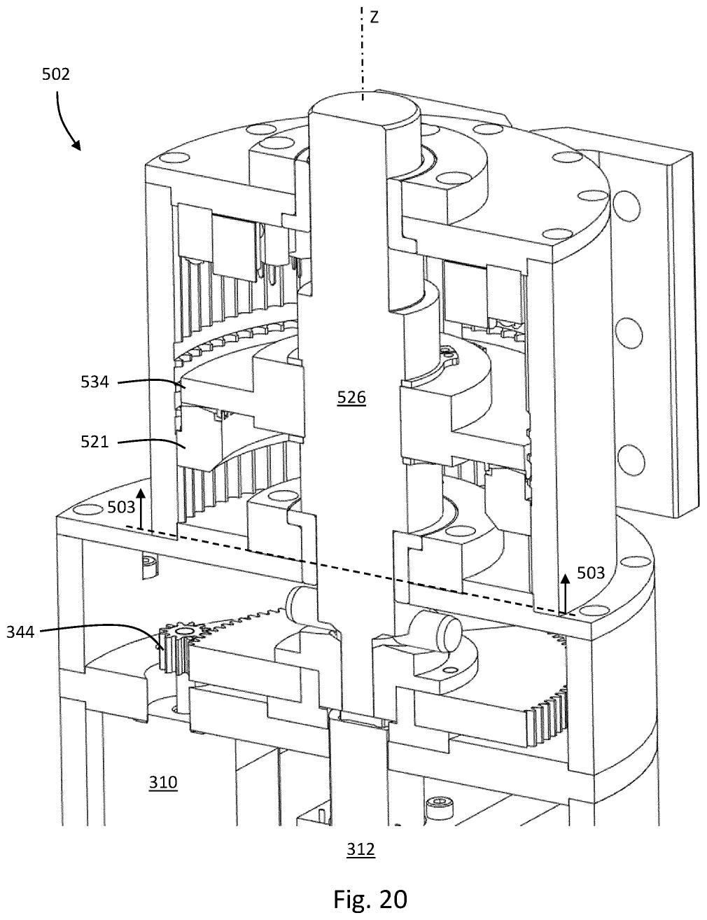

FIG. 20 is a perspective section view of the first drive mounting unit of FIG. 18;

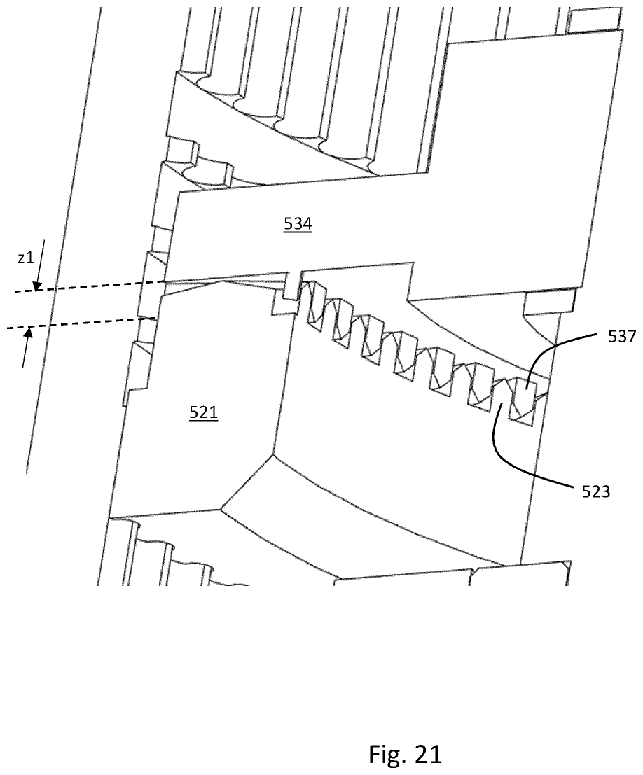

FIG. 21 is a detail view of a part of the unit of FIG. 18;

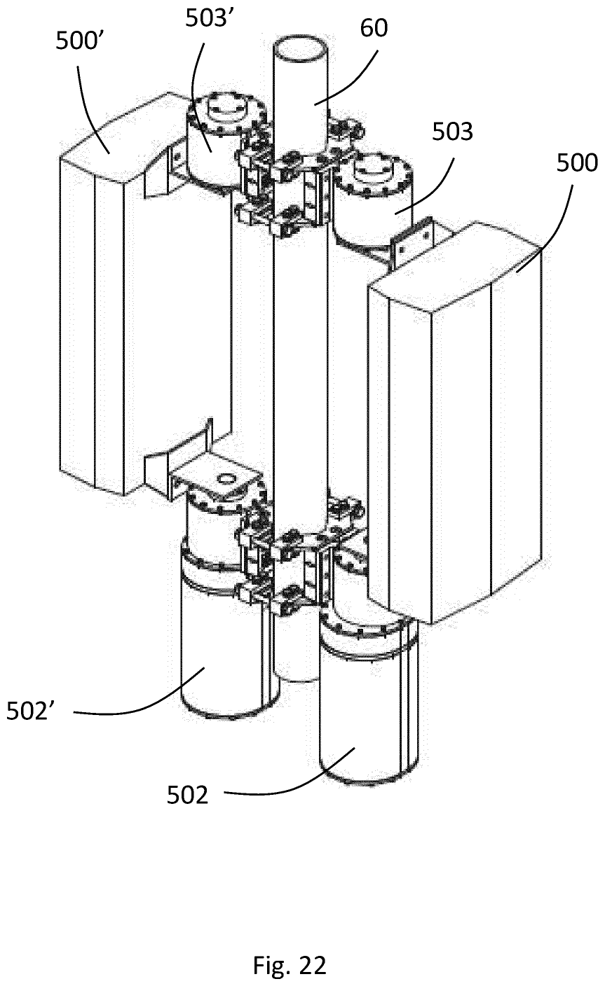

FIG. 22 is a perspective view of two antennas mounted to an antenna mast;

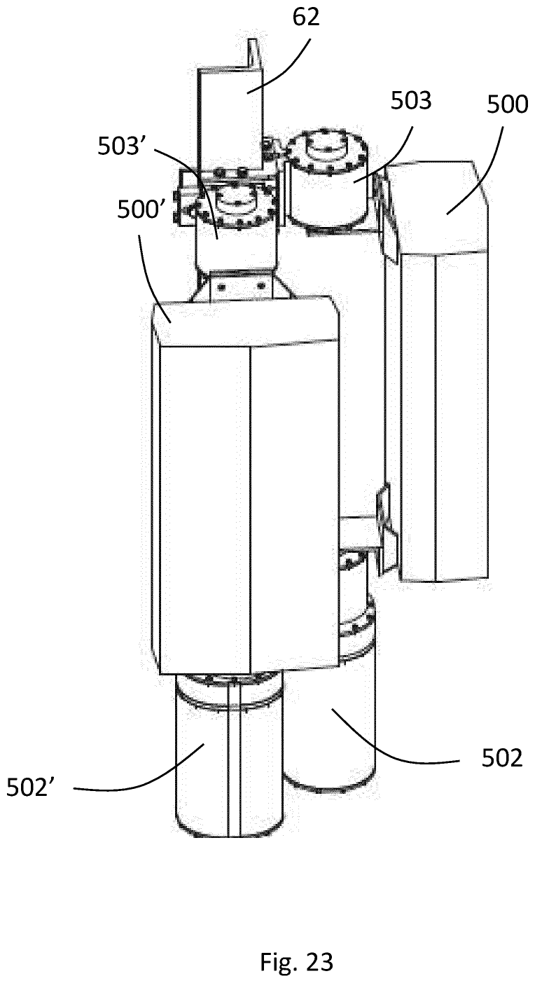

FIG. 23 is a perspective view of two antennas mounted to an antenna mast;

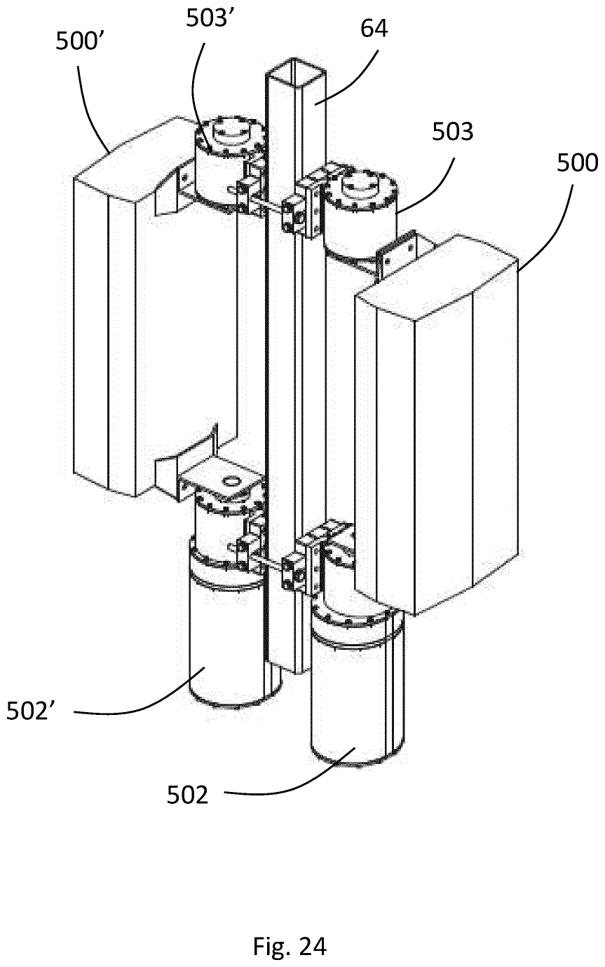

FIG. 24 is a perspective view of two antennas mounted to an antenna mast;

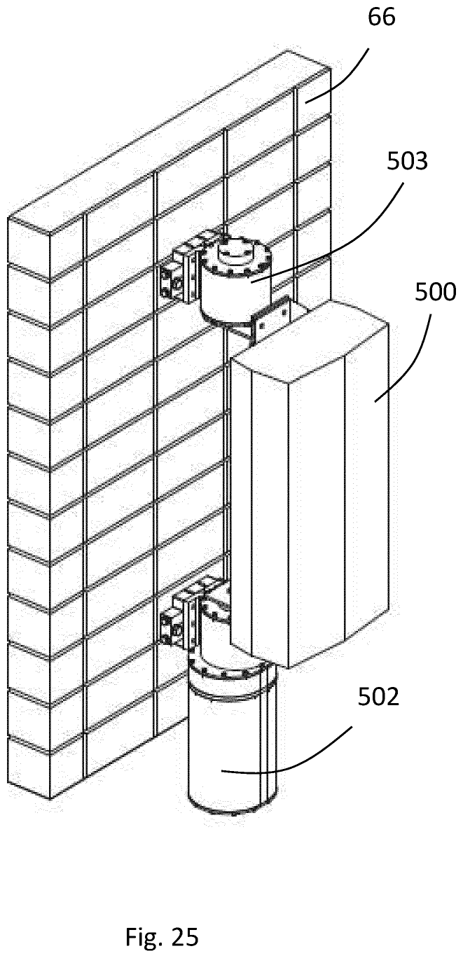

FIG. 25 is a perspective view of an antenna mounted to a wall;

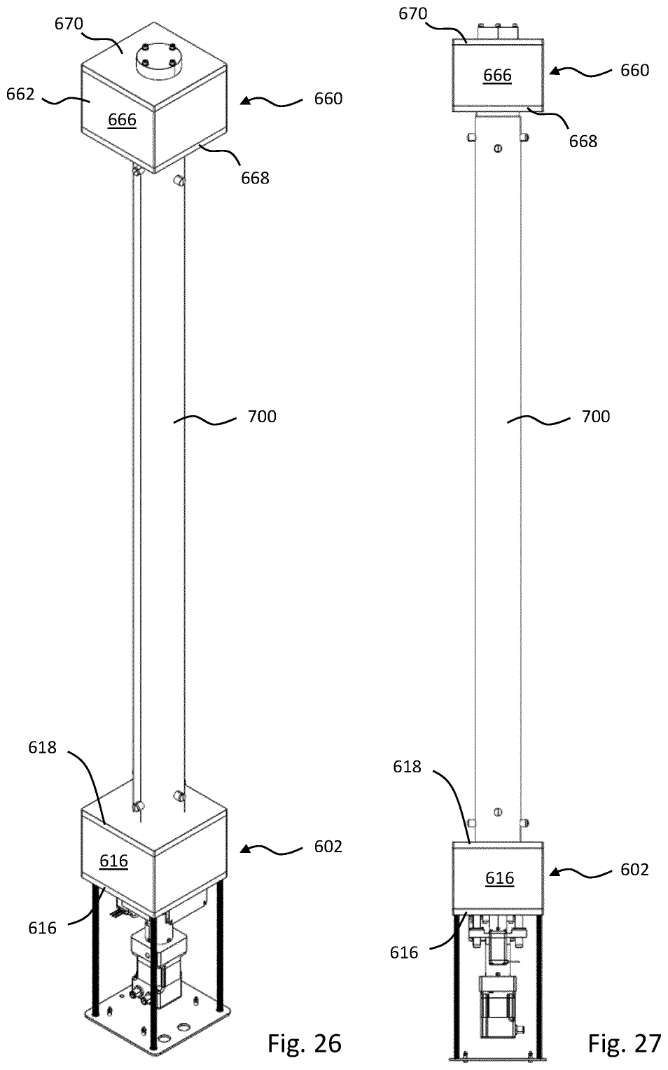

FIG. 26 is a perspective view of a third embodiment of the present invention;

FIG. 27 is a side view of the third embodiment;

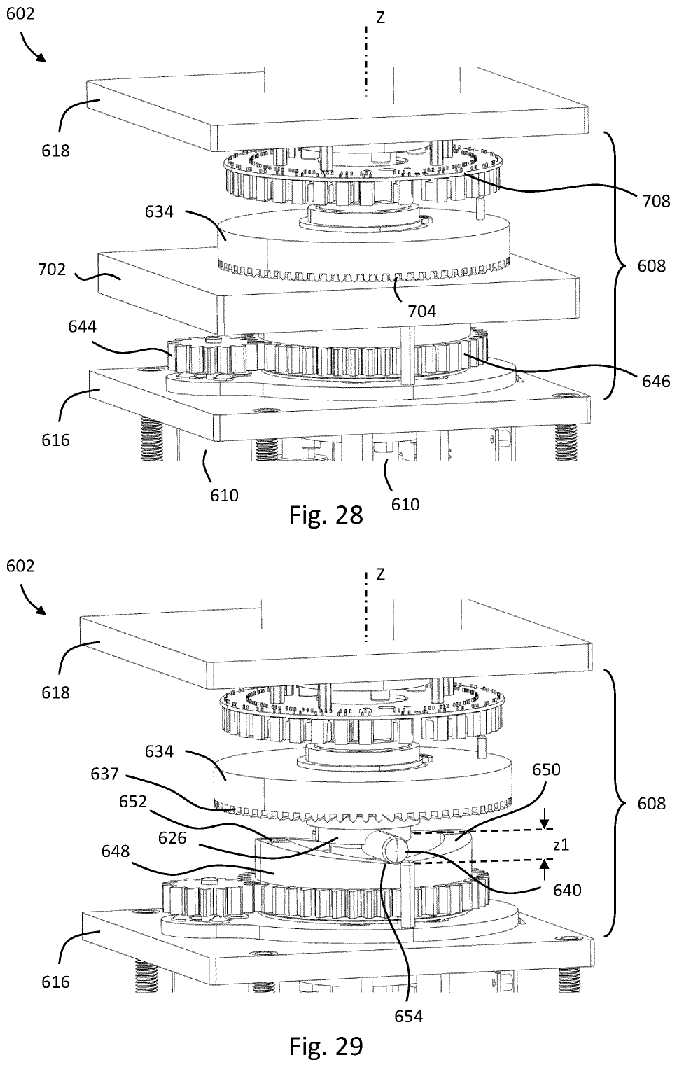

FIGS. 28 and 29 are detail views of a first subassembly of the third embodiment;

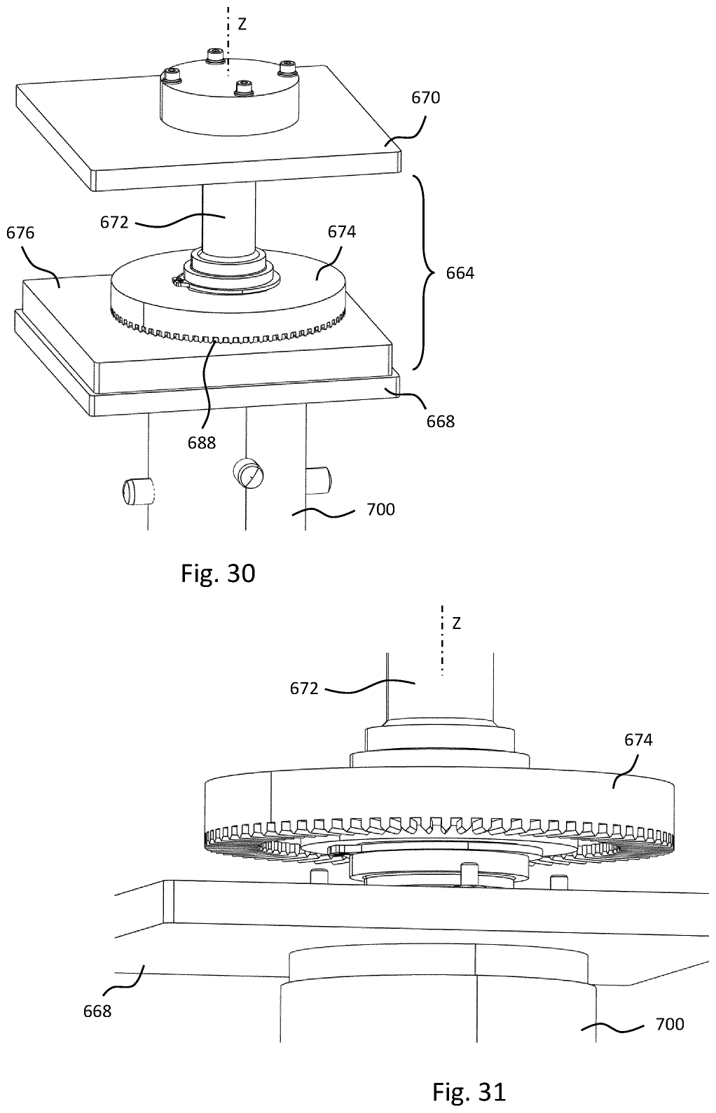

FIGS. 30 and 31 are detail views of a second subassembly of the third embodiment;

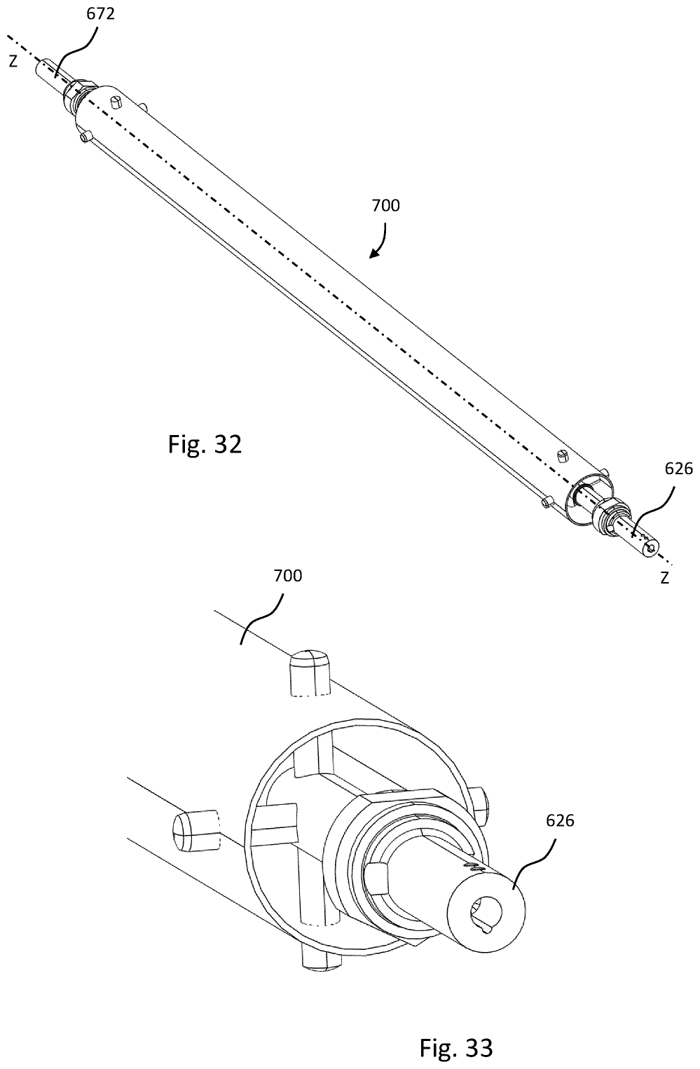

FIGS. 32 and 33 are detail views of a third subassembly of the third embodiment;

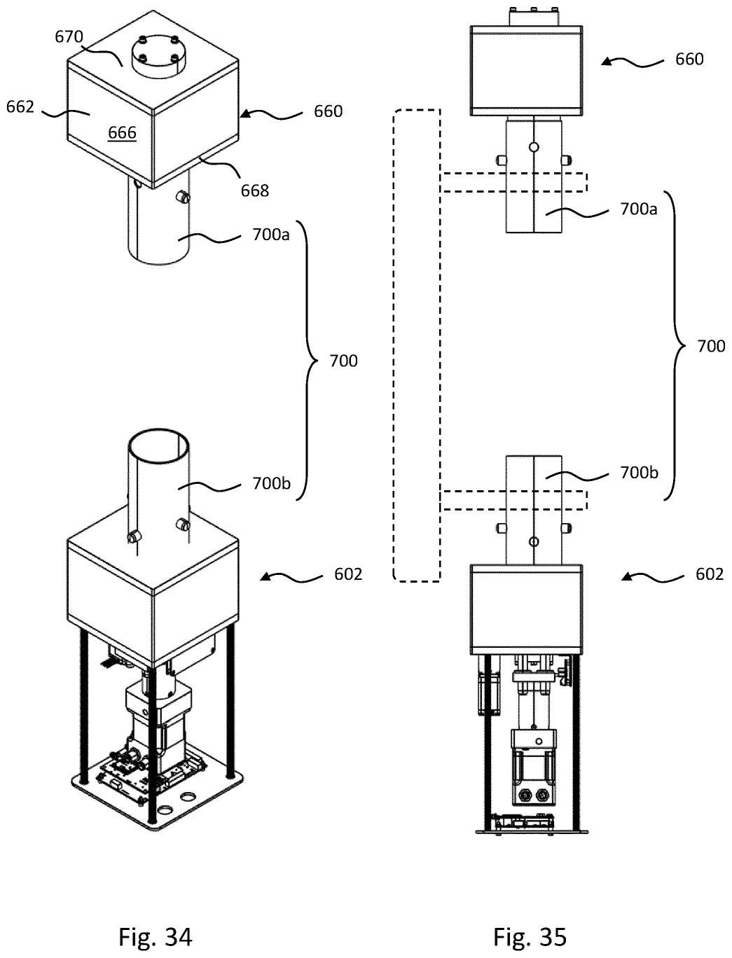

FIG. 34 is a perspective view of a fourth embodiment of the present invention;

FIG. 35 is a side view of the fourth embodiment.

Referring to FIG. 1, an antenna 100 is shown mounted to an antenna mast 10. The antenna 10 is a directional panel antenna for example as used in a cellular network, and is mounted for rotation about an azimuth steering axis Z. A tilt axis Y and roll axis X are also shown in FIG. 1. A reference frame 12 is mounted to the mast 10. The position of the reference frame 12 has been measured accurately by a global positioning sensor. Therefore, the exact orientation of the frame 12 is known. The antenna 100 is attached to the reference frame 12 by a first mounting unit 102 and a second mounting unit 104 which are spaced-apart and aligned on the azimuth axis Z. The mounting apparatuses are configured to allow the user to adjust and determine the relative orientation between the reference frame 12 and the antenna 100, and thus to calculate the absolute orientation of the antenna 100.

The following embodiments of the present invention may be used in place of the first and second mounting units 102, 104.

### First Embodiment

The first embodiment comprises two mounting units 302, 360.

### Mounting Unit 302

Turning to FIGS. 2a to 7, a mounting unit 302 is shown. The mounting unit 302 may be used instead of the first (lower) mounting unit 102 in FIG. 1.

The first mounting unit 302 is shown in section FIG. 4, and comprises a housing 306, a rotary locking mechanism 308 contained within the housing 306 and first and second actuators 310, 312 mounted to the housing 306.

Referring to FIG. 4, the housing 306 comprises a tubular, cylindrical sidewall 314 and two opposed endwalls 316, 318. The sidewall 314 and endwalls 316, 318 cooperate to delineate a cylindrical volume containing the locking mechanism 308.

The sidewall 314 defines a plurality of axially extending grooves 320. The grooves are interrupted by a plurality (four in this embodiment) circumferential channels 322a-322d. Between each channel there are ridges 324a-c in which the axially extending grooves are also formed.

The locking mechanism 308 comprises a primary drive shaft 326 protruding from both endwalls 316, 318 of the housing 306. A first end 328 comprises an attachment 330 for a motor shaft. The second end 332 is the output to the antenna for steering. The shaft 326 is aligned with the azimuth steering axis Z.

Connected to the shaft there is provided a locking plate stack 334. The plate stack comprises four locking plates 336a-d and five spacer plates 338a-e. The plates alternate. The perimeter of the locking plates 336a-d is generally circular, defining a ridged formation 337 configured to mate (i.e., to interdigitate with) the interior of the grooves 320 on the sidewall. The spacing plates 338a-e are smaller in diameter and do not contact the sidewall.

A follower 340 is provided which is a solid cylinder. The follower is mounted through the centre of the shaft 326 and is oriented with its axis normal thereto. The follower 340 extends either side of the shaft 326 as depicted in FIG. 10a.

The shaft is capable of moving along the Z axis by distance z1 (FIG. 3b).

The locking mechanism 308 comprises a rotary—linear actuator 342 having a drive gear 344, a driven gear 346 and a collar 348 having a cammed annular axially facing surface 350. The collar 348 is attached to the driven gear 346 and is shown in more detail in FIG. 7. The surface 350 is curved extending from a pair of diametrically opposed peaks 352 to a pair of diametrically opposed troughs 354 at 90 degrees thereto. The distance between the peaks 352 and troughs 354 in the Z axis is z1. The collar 348 has a central aperture 356.

### Mounting Unit 360

Turning to FIGS. 8 to 9, a second mounting unit 360 is shown. The mounting unit 360 may be used instead of the second (upper) mounting unit 104 in FIG. 1, in combination with the first (lower) mounting unit 302.

The second mounting unit 360 is shown in section FIG. 9 and comprises a housing 362 and a rotary locking mechanism 364 contained within the housing 362.

Referring to FIG. 9, the housing 362 comprises a tubular, cylindrical sidewall 366 and two opposed endwalls 368, 370. The sidewall 366 and endwalls 368, 370 cooperate to delineate a cylindrical volume containing the locking mechanism 364.

The locking mechanism 364 comprises a primary drive shaft 372, a first locking plate stack 374 and a second locking plate stack 376. The shaft 372 protrudes from both endwalls 368, 378 of the housing 362. A first end 376 comprises an attachment 378 for the antenna. The shaft 372 is aligned with the azimuth steering axis Z.

Connected to the shaft there is provided the first locking plate stack 374. The plate stack comprises four locking plates 380a-d and five spacer plates 382a-e. The plates alternate. The perimeter of the locking plates 380a-d is generally circular, defining a ridged formation 384. The spacing plates 382a-e are smaller in diameter than the locking plates 380a-d.

The second locking plate stack 376 is attached to the housing 362. It also comprises four locking plates 385a-d and five spacer plates 386a-e. The perimeter of the locking plates 384a-d is generally circular, defining a ridged formation 388. The spacing plates 386a-e are smaller in diameter than the locking plates 384a-d.

The first locking plate stack 374 and the second locking plate stack 376 configured to mate to lock the shaft 372 against rotation.

The shaft is capable of moving along the Z axis by distance z1 (FIG. 9) between a locked condition (shown in FIG. 9) in which the plates are aligned and mated, and an unlocked condition in which the plates are not aligned and free to rotate relative to each other.

### Use

The locking mechanism 364 operates as follows.

In the lower (locked) condition shown in FIG. 2a through 9, the collar 348 of the lower mounting unit 302 is in a rotational position (about Z) such that the follower 340 sits in the troughs 354. In this position, the shaft 326 is in a lower position and the locking plates 336a-d are engaged with the grooves 320. This is shown in detail in FIG. 5, where the top locking plate 336a is omitted, and the mating between the ridges 337 of the locking plate 336b and the housing grooves 320 is shown. In this position, the shaft 326 is rotationally locked about the azimuth steering axis Z, and cannot be back driven by e.g., wind loading.

At the same time, the second (upper) mounting unit 360 is also in the locked condition shown in FIG. 9.

In this condition, both ends of the antenna are locked in position, and will resist any movement by external loading at two spaced-apart position, thereby also avoiding torsion loading.

The antenna can be rotated by moving both mounting units 302, 360 to the unlocked condition. This is achieved by vertical movement (along axis Z) by distance Z1. The drive gear 334 is rotated by the motor 310. This rotates the driven gear 346 which rotates the collar 348. As the collar 348 rotates, the surface 350 moves such that the follower 340 is lifted upwardly along the Z direction. As this happens, the locking plates of both mounting units 302, 360 are lifted to disengage with the corresponding locking formations mounted to the respective housings. This allows rotation of the shaft 326 (and therefore the antenna and shaft 372) by the motor 312.

It will be noted that in order to retain the mounting units 302, 360 in the unlocked condition, the collar 348 and the follower 340 need to be kept stationary relative to each other. Therefore as the shaft 326 is driven, the collar 346 is too, maintaining alignment.

Once the motor 312 has rotated the antenna to the desired position, the drive gear 334 is once again rotated to allow the mounting units 302, 360 to move back to the locked position under gravity. It will be noted that even if the grooves are not perfectly aligned, any small amount of movement of the antenna (e.g., by wind loading) will rotate the shaft allowing the locking plates to drop into position in the locked condition.

A rotary encoder (not shown) is used to determine the rotation position of the antenna shaft, which feeds back to a controller for the motors 312.

The unit 302 is effectively the “master” and the unit 360 the “slave”.

### Second Embodiment

Referring to FIG. 10, a perspective view of a mounting unit 402 is shown. The mounting unit 402 may be used instead of the mounting unit 102 in FIG. 1. The mounting unit 402 offers locking and steering capability but utilises a Geneva wheel type rotary indexer to facilitate incremental movement and locking with a single input drive (rather than the double motor arrangement of the first embodiment).

Referring to FIGS. 10 to 16, the first mounting unit 402 comprises a drive mechanism 406 having:
A motor 401 driving an input shaft 417;
A rotary indexer 418 having:
   A drive wheel 420; and,
   A driven wheel 422;
A pinion gear shaft 440 having a pinion gear formation 450;
A partial ring gear 456;
A ring gear carrier 458;
an Output Shaft 432.

The drive wheel 420 is shown in FIG. 16. It has a first side portion 424, a second side portion 425, a drive pin 426 and a locking member 428. The locking member describes a circle segment outer surface 430. The second side portion 425 comprises a disc portion 429 with a shaft 431 extending axially therefrom. The disc portion has a switch abutment 427 extending radially therefrom. Surrounding the shaft 431 on one side of the second side portion there is provided an axially facing annular cammed surface 433 having a peak 433a and a trough 433b located at different positions along the axis IA.

The input shaft 408 is defined on the second side portion for rotation about an input axis IA. The input shaft is driven by a rotary actuator 401 about the input axis IA.

The driven wheel 422 defines n equidistant radial slots 434 (where n=12 in this embodiment). Between each slot 434 there is provided a concave circle segment 436. The driven wheel 422 defines a central opening 438. The drive wheel 420 and driven wheel 422 form a Geneva wheel rotary indexing mechanism (best illustrated in FIG. 14).

The pinion gear formation 450 comprises a plurality of external gear teeth 452.

The partial ring gear 456 is annular in shape, describes a 180-degree circle segment and comprises a plurality of internal gear teeth 459 on its inner periphery. The output shaft 432 is fixed to, and extends to a first side of, the ring gear 456 (rotation of the gear causing rotation of the output shaft). On the opposite side of the ring gear 456 to the output shaft 432 there is provided a lifting plate 470 comprising a follower 468 extending therefrom.

The ring gear carrier 468 comprises a cylindrical upper housing 460 to which a plurality of inwardly extending ring gear supports 462, 464 extend. The ring gear bears against (but rotates relative to) the ring gear supports 462, 464 and is contact therewith via a sliding part-cylindrical joint CJ. Also extending inwardly from the housing 460 there is provided a follower arm 466 terminating in a slot containing the follower 468 which can move parallel to the axis IA within the slot.

The output shaft is rotatable about an axis OA which is parallel with, and aligned to the input axis IA.

The drive wheel 432 and the ring gear 456, although aligned, are rotatable relative to each other by means of a bearing 472 surrounding the shaft 432 and supporting it within the ring gear 456.

### Use

The mounting unit 402, like the mounting unit 302, can be moved between a locked and unlocked condition to allow rotation of the antenna. In the condition shown in FIGS. 10 to 16, the antenna is in the locked condition.

Activation of the motor 401 drives the input shaft 417. This rotates the drive wheel 420. From the position shown, the Geneva arrangement is in the centre of its dwell phase, and the driven wheel 422 remains static. As rotation of the drive wheel 420 continues, the cammed surface 433 lifts the follower 468 which in turn lifts the ring gear 456 and output shaft 432 along the axis OA (i.e., along the aximuth steering axis Z).

Eventually, continued rotation of the drive wheel 432 results in the drive pin 426 entering a slot 434 on the driven wheel 422 (whilst the antenna is lifted) to apply a fixed amount of rotation (360/n=30 degrees). This in turn drives the pinion gear formation 450 which drives the partial ring gear 456 and thus the output shaft 432 to rotate the antenna.

As the drive wheel 432 continues to rotate, the null phase is entered and the cam follower 468 rides into the trough 433b of the surface 433 to lock the antenna again. Continued rotation of the motor 401 will index antenna movement, repeatedly rotating and locking the mechanism.

Referring to FIG. 17, a motion profile of D1 (rotation angle of the input shaft 417) vs D2 (rotation angle of the driven gear 422) is shown. For each rotation of the drive wheel 420 (D1=360) the driven wheel 422 has a motion phase M and a dwell phase D. In the motion phase, the pin 426 is engaged with a slot 424. Rotation of the drive wheel 420 results in the pin 426 both sliding radially into the slot 424 and rotating the driven wheel 422. When the pin leaves the slot the Geneva drive enters the dwell phase D. In this phase the outer surface of the locking member 428 engages the concave circle segment 436. This engagement prevents rotation of the driven wheel 422 and essentially locks the Geneva drive in position.

The pinion gear 440 and ring gear 456 act as a reduction gear.

Preferably the set point SP is positioned to be at least 5 degrees from each end of the dwell range D. In this way, minor errors in motor shaft positioning do not affect the positioning of the antenna. Furthermore, any mechanical slack in the motor (e.g. due to backlash) is not problematic as the antenna is locked in position by the Geneva drive in the dwell phase.

A further benefit of the Geneva drive is that under loading the antenna cannot be back driven, particularly in the dwell phase (as the drive wheel and driven wheel are locked).

In this embodiment, the mounting unit 360 is used at the opposite end of the antenna. This is why the mounting unit 402 lifts and lowers the antenna—to provide locking and unlocking at the opposite end of the antenna (at a position spaced apart from the mounting unit 402). This avoids antenna twisting/torsion loading.

The unit 402 is effectively the “master” and the unit 360 the “slave”.

### Third Embodiment

Referring to FIGS. 18a & 18b, there is shown an antenna 500 mounted to an antenna mast member 50. The antennas 500 is a directional panel antenna, and is mounted for rotation about an azimuth steering axis Z. The antenna mast member 50 is an angle or “L”section.

The antenna 500 is mounted to the mast member 50 via a master steering and clamping assembly 52 and a slave steering and clamping assembly 54. The master assembly 52 comprises a mast clamp 56 and a master steering and locking unit 502 attached thereto. The slave assembly 54 comprises a mast clamp 58 and a slave steering and locking unit 503 attached thereto.

The clamps 56, 58 comprise at least two members (56′, 56″, 58′, 58″) on either side of the mast section which are configured to mate therewith, and to be tightened via fasteners to clamp the mast section therebetween and support the antenna by mechanical friction alone.

Referring to FIGS. 19 to 21, a perspective view of a steering and locking unit 502 is shown. The mounting unit 502 offers locking and steering capability, like the unit 302, but instead of a gear formation (with radially extending teeth) uses a clutch formation-specifically a dog clutch with axially extending teeth.

Unlike the housing of the unit 302, the housing of the unit 502 comprises a first clutch plate 521 extending inwardly. The plate 521 is annular and defines a plurality of axially extending teeth 523. The teeth are tapered (FIG. 20).

The unit 502 comprises a locking mechanism 508. The locking mechanism 508 comprises a primary drive shaft 526 protruding from both endwalls of the housing as with the unit 302. Connected to the shaft 526 there is provided a second clutch plate 534. The second plate 534 defines a plurality of axially extending tapered teeth 537 configured to mate (i.e., to interdigitate with) the teeth 523 first clutch plate 521. The plates 521, 534 in this embodiment are constructed from a plastics material such as POM, but in another embodiment they are constructed from a metal material such as aluminium or steel.

Like in the unit 302, the shaft 526 is capable of moving along the Z axis by distance z1.

Therefore when the locking motor is driven, the shaft (and plate 534) are lifted out of engagement with the plate 521 and as such the antenna can be steered.

The unit 503 (the slave unit) comprises the same components of the unit 502 above the line marked 503 in FIG. 20. Therefore the slave unit 503 has locking capability dependent on vertical movement.

The unit 502 is effectively the “master” and the unit 360 the “slave”. The master unit is active (powered) and the slave unit is passive (unpowered).

In use, the master (and slave) units are simultaneously unlocked by rotation of the gear 344 powered by motor 310. Rotation lifts the shaft 526 and hence the antenna 500 in a direction along the azimuth steering axis Z. This vertical motion acts to unlock the dog clutch of the slave unit 503. Simultaneous unlocking allows the antenna to be steered by the motor 312. In this embodiment, the motor 312 comprises a planetary gearbox, which has the advantage of not allowing it to be back driven by external loads on the antenna when unlocked.

FIGS. 22 to 26 show the units 502, 503 in a number of different installations:
FIG. 22 shows first antenna 500 and a second antenna 500′ attached either side of a pole by a pair of pole clamps. Units 502, 502′, 503, 503′ are positioned on either side of a pole 60.
FIG. 23 shows first antenna 500 and a second antenna 500′ attached at two sides (90 degrees apart) of an angle section by a pair of pole clamps. Units 502, 502′, 503, 503′ are positioned on either side of an angle section 62.
FIG. 24 shows first antenna 500 and a second antenna 500′ attached either side of a pole by a pair of pole clamps. Units 502, 502′, 503, 503′ are positioned on either side of a square pole 64.
FIG. 25 shows first antenna 500 attached to a wall 66.

### Implementation

Although in each of the above embodiments the mechanism provides indexing (i.e. a known rotation of the antenna for a given rotation of the motor), the invention provides a rotary position sensor to measure the rotation of the output shaft 132. This will provide an accurate understanding of the antenna position and allow the appropriate locking position to be determined for the motor.

In each embodiment, the indexer has a limited range of motion (for example +/−90 degrees). This is facilitated by a stop mechanism which prevents further movement of the mechanism beyond the predetermined range to prevent clashes with e.g. the mast. It will be noted that the range of motion of the third embodiment is inherently limited by the partial ring gear. In the present embodiment, the dog clutch has 5 degree increments, although other angular increments are envisaged.

The present invention is particularly well suited to a method similar to that disclosed in WO2013171291. Accurate global (absolute) orientation and position of the antenna can be determined with the present invention in a low cost manner, requiring no position sensing equipment to be retained on the apparatus.

According to the present invention, the absolute position of the reference frame 12 is determined by a global positioning sensor. This can determine e.g. the global azimuth heading of the frame with respect to magnetic North, and its orientation in a tilt sense with respect to the centre of the earth's gravity for tilt. Once this data is obtained, it can be delivered to the controller 114, and the global positioning sensor removed from the reference frame 12.

Accurate positioning of the antenna 100 can then be determined as the controller can combine the relative position setting of the drive mechanism with the global position of the reference frame to provide the global position of the antenna.

### Third Embodiment

The third embodiment comprises two mounting units 602, 660, and a shaft 700 extending therebetween.

### Mounting Unit 602

Turning to FIGS. 28 and 29, the mounting unit 602 is shown. The first mounting unit 602 comprises a housing 606, a rotary locking mechanism 608 contained within the housing 616 and first and second actuators 610, 612 mounted to the housing 606.

Referring to FIG. 26, the housing 606 comprises a tubular, square-section sidewall 614 and the two opposed endwalls 616, 618. The sidewall 614 and endwalls 616, 618 cooperate to delineate a cuboidal volume containing the locking mechanism 608.

The locking mechanism 608 comprises a primary drive shaft 626 protruding from both endwalls 616, 618 of the housing 606. A first end is driven by the motor 610. The second end is connected to the shaft 700. The primary drive shaft is aligned with an azimuth steering axis Z.

Connected to the shaft there is provided a locking plate 634. The locking plate is annular, comprising a plurality of axially directed teeth 637 on its underside, forming one half of a dog clutch.

A follower 640 is provided which is a solid cylinder. The follower is mounted through the centre of the shaft 626 and is oriented with its axis normal thereto. The follower 640 extends either side of the shaft 626 as depicted in FIG. 29.

The shaft 626 is capable of moving along the z axis by distance Z1 (figure 29).

The locking mechanism 608 comprises a drive gear 644, a driven gear 646 and a collar 648 having a cammed annular axially facing surface 650. The collar 648 is attached to the driven gear 646. The surface 650 is curved extending from a pair of diametrically opposed peaks 652 to a pair of diametrically opposed troughs 654 at 90 degrees thereto. The distance between the peaks 652 and troughs 654 in the Z axis is z1. The collar 648 is annular—i.e., has a central aperture.

Within the housing 606 and secured thereto is a second locking plate 702. The second locking plate 702 is keyed to the housing (in this embodiment it is also square in profile). On a surface of the second locking plate 702 there is provided an annular arrangement of axially extending teeth 704 surrounding a shaft aperture. The second locking plate 702 forms a second half of the dog clutch.

### Mounting Unit 660

Turning to FIGS. 30 to 31, the second mounting unit 660 is shown.

The second mounting unit 660 comprises a housing 662 and a rotary locking mechanism 664 contained within the housing 662.

Referring to FIG. 26, the housing 662 comprises a tubular, square section sidewall 666 and two opposed endwalls 668, 670. The sidewall 666 and endwalls 668, 670 cooperate to delineate a volume containing the locking mechanism 664.

The locking mechanism 664 comprises a primary drive shaft 672, a first locking plate 674 and a second locking plate 676. The shaft 672 protrudes from both endwalls 668, 678 of the housing 662. The shaft 672 is aligned with the azimuth steering axis Z.

Connected to the shaft there is provided the first locking plate 674. The locking plate 674 is generally annular comprising a set of axially extending teeth 680. The plate 674 forms one half of a dog clutch.

The second locking plate 676 is attached to the housing 662. It also comprises a locking plates being square in form and defining a set of axially extending teeth 688 in an annular formation.

The first locking plate 674 and the second locking plate 676 are configured to mate to lock the shaft 672 against rotation (i.e., they form a dog clutch). They can be disengaged by vertical movement of the shaft (and hence the first plate 674) along the axis X.

The shaft 700 is shown in more detail in FIGS. 32 and 33. It is hollow, circular in cross section and has a diameter capable of supporting an appropriate antenna under static and dynamic (wind) loading conditions. The shafts 626, 672 are each attached to either end of the shaft 700 to transfer both linear and rotational movement thereto. The shafts 626, 672 are separate and distinct, and as such linear and rotational forces between them is carried by the shaft 700.

### Use

In use, the units 602, 660 are mounted to an antenna mounting structure such as a mast.

The third embodiment has two states-locked and unlocked. The locked state is shown in the Figures in which the collar 648 of the lower mounting unit 602 is in a rotational position (about Z) such that the follower 640 sits in the troughs 654. In this position, the shaft 626 is in a lower position and the locking plate 634 is engaged with the plate 702 (i.e. the dog clutch is locked).

At the same time, the second (upper) mounting unit 660 is also in the locked condition shown in FIG. 30 with the plates 674, 676 engaged.

In this condition, the shaft 700 is locked in position from both ends, and will resist any movement by external loading at two spaced-apart positions, thereby also avoiding torsion loading.

The shaft 700 can be rotated by moving both mounting units 602, 660 to the unlocked condition. This is achieved by vertical movement (along axis Z) by distance Z1. The drive gear 634 is rotated by the motor 610. This rotates the driven gear 646 which rotates the collar 648. As the collar 648 rotates, the surface 650 moves such that the follower 640 is lifted upwardly along the Z direction. As this happens, the locking plates of both mounting units 602, 660 are lifted to disengage with the corresponding dog clutch plates. This allows rotation of the shaft 626 (and therefore the shaft 700) by the motor 612.

It will be noted that in order to retain the mounting units 602, 660 in the unlocked condition, the collar 648 and the follower 640 need to be kept stationary relative to each other. Therefore as the shaft 626 is driven, the collar 646 is too, maintaining alignment.

Once the motor 612 has rotated the shaft 700 to the desired position, the drive gear 634 is once again rotated to allow the mounting units 602, 660 to move back to the locked position under gravity. It will be noted that even if the teeth are not perfectly aligned, any small amount of movement of the shaft (e.g., by antenna wind loading) will rotate the shaft allowing the locking plates to drop into position in the locked condition.

A rotary encoder 708 is used to determine the rotation position of the shaft 626, which feeds back to a controller for the motors.

The unit 602 is effectively the “master”and the unit 660 the “slave”.

This embodiment allows an antenna to be mounted to the shaft 700 using legacy brackets. In known legacy systems, a pipe or pole is mounted offset from a mast, and an antenna mounted thereto using two spaced apart pole clamps. A first side of the pole clamp is attached to the backplane, and a second side forms a clamp to grip the pole. When steering takes place, a technician needs to undo the clamps, rotate the antenna by hand, and refasten them.

In the present invention, the antenna can be mounted to the shaft 700 in the same manner as the legacy pole, but instead of manual adjustment, azimuth steering can take place by pole rotation without needing to undo the clamps.

### Fourth Embodiment

The fourth embodiment shown in FIGS. 34 and 35 is identical to the third embodiment with the exception of the shaft 700 being split in two parts 700a, 700b having a first portion attached to the shaft 626 and a second attached to the shaft 672. In this instance, instead of the shaft 700 carrying all or part of the vertical and rotational motion, the antenna would do so (depicted schematically in dashed lines).

### Variations

Variations exist within the scope of the present invention.

Rotary transducers may also (or instead) be positioned on the input shafts 108.

A 12-position Geneva drive is shown, but it will be understood that this may be varied depending on space constraints.

Aside from external Geneva drives (as shown in the embodiments), other rotary indexers may be used. For example, internal Geneva drives may be utilised. This type of drive tends to be more compact than the external type discussed above. Three-dimensional (i.e. spherical) Geneva drives may also be employed. The inverted Geneva mechanism provides a lower-cost solution as it can be constructed from off-the-shelf and simply manufactured components, without the need for profile cutting with the other types of Geneva drive.

Other reduction gears may be utilised-for example worm gears, which advantageously add additional resistance to reverse driving.

Although azimuth steering is described above, the present invention may be used for rotation to enable tilt or roll of the antenna in addition to, or instead of, azimuth steering.

The third and fourth embodiments are shown with a motorised, electromechanical steering and locking unit on the lower end a steering and locking unit on the top end. It will be understood that the units may provide locking only—i.e. be a means to lock and release the central tube or tubes 700. For example, the antenna may be steered manually when in the unlocked condition. It will be further understood that the locking mechanism need not be a dog clutch or Geneva wheel as depicted. For example, any of the steering and locking units depicted in the client's earlier patent EP2850689 may be utilised.

1-28. (canceled)

29. An antenna mounting apparatus comprising:
a locking unit;
at least one hollow cylindrical section connected to the locking unit, the hollow cylindrical section having a cylindrical outer surface;
wherein the locking unit is configured to selectively allow and inhibit rotation of the hollow cylindrical section about a steering axis;
an antenna;
a first clamp and a second clamp, each clamp attached to the antenna in spaced apart positions, and each clamp clamping the at least one hollow cylindrical section with friction to thereby prevent rotation of the respective clamp about the hollow cylindrical section.

30. The antenna mounting apparatus according to claim 29, wherein the locking unit comprises a friction clutch.

31. The antenna mounting apparatus according to claim 29, wherein the locking unit comprises a locking pin engageable with any of a plurality of receiving formations in a locking plate.

32. The antenna mounting apparatus according to claim 29, wherein the locking unit is a first steering and locking unit, the first steering and locking unit having a bearing supporting rotation of the hollow cylindrical section.

33. The antenna mounting apparatus according to claim 32, wherein the first steering and locking unit has an actuator for rotating the hollow cylindrical section.

34. The antenna mounting apparatus according to claim 32, comprising:
a second steering and locking unit;
the first and second steering and locking units connected to the at least one hollow cylindrical section at spaced apart positions.

35. The antenna mounting apparatus according to claim 34, wherein the first clamp and the second clamp each clamp the hollow cylindrical section at spaced apart positions between the first and second steering and locking units.

36. The antenna mounting apparatus according to claim 34, wherein the first and second steering and locking units each comprise a rotary output shaft, each respective rotary output shaft connected to a respective open end of a common hollow cylindrical section.

37. The antenna mounting apparatus according to claim 35, wherein each respective rotary output shaft extends within the respective open end of the common hollow cylindrical section.

38. The antenna mounting apparatus according to claim 36, comprising spokes extending from each rotary output shaft to engage the common hollow cylindrical section.

39. The antenna mounting apparatus according to claim 34, wherein the first and second steering and locking units are actuated between a locked and an unlocked condition by axial motion, which axial motion is transmitted between the first and second steering and locking mechanisms via the at least one hollow cylindrical section.

40. The antenna mounting apparatus according to claim 29, comprising:
a second steering and locking unit;
the first and second steering and locking units connected to respective distinct hollow cylindrical sections;
wherein the first clamp and the second clamp each clamp a respective hollow cylindrical section.

41. An antenna mounting apparatus comprising:
directional antenna;
a master locking and steering unit for mounting the antenna to a fixed structure, the master locking and steering unit provided at a first position on the antenna;
a slave locking and steering unit for mounting the antenna to the fixed structure, the slave locking and steering unit provided at a second position on the antenna, spaced apart from the first;
wherein:
the slave locking and steering unit has a locked condition and an unlocked condition, and movement from the locked condition to the unlocked condition is provided by a motion input; and,
the master locking and steering unit has a locked condition and an unlocked condition, and movement between the locked condition and unlocked condition provides the motion input to the slave locking and steering unit.

42. The antenna mounting apparatus according to claim 40, wherein the master locking and steering unit is active, and wherein the slave locking and steering unit is passive.

43. The antenna mounting apparatus according to claim 40, wherein the motion input is a motion along an azimuth steering axis of the antenna.

44. The antenna mounting apparatus according to claim 42, wherein the motion input is a motion of the antenna.

45. The antenna mounting apparatus according to claim 43, wherein the master locking and steering unit comprises a lifting mechanism to move the antenna parallel to the azimuth steering axis.

46. The antenna mounting apparatus according to claim 44, wherein the lifting mechanism comprises a rotational input.

47. The antenna mounting apparatus according to claim 45, wherein the lifting mechanism comprises a cam and follower, the cam driven by the rotation input to drive the follower parallel to the azimuth steering axis.

48. The antenna mounting apparatus according to claim 41, wherein at least one of the master locking and steering unit and slave locking and steering unit comprises:
a housing;
a first locking formation connected to an output shaft;
a second locking formation connected to the housing;
wherein:
in the locked condition the first locking formation and the second locking formations are engaged; and,
in the unlocked condition the first locking formation and the second locking formation are disengaged to allow rotation of the output shaft.

49-63. (canceled)
